(19) United States
(12) Patent Application Publication
(10) Pub. No.: US 2007/0073961 A1
(43) Pub. Date: Mar. 29, 2007

(54) MEMORY CONTROLLER

(75) Inventor: Atsushi YABUSHITA, Kanagawa (JP)

Correspondence Address: GLOBAL IP COUNSELORS, LLP, 1233 20TH STREET, NW, SUITE 700, WASHINGTON, DC, 20036-2680, US

(73) Assignee: OKI ELECTRIC INDUSTRY CO., LTD., Tokyo (JP)

(21) Appl. No.: 11/532,070

(22) Filed: Sep. 14, 2006

(30) Foreign Application Priority Data
Sep. 28, 2005 (JP) 2005-281707

(51) Int. Cl. G06F 12/08

(52) U.S. Cl. 711/3

(57) ABSTRACT

A memory controller includes a plurality of buffers and a controller. The buffers are connected with a predetermined memory. The controller issues a first command before all the buffers store data. The first command is an instruction to activate a row address corresponding to a predetermined memory region in the predetermined memory, and it is generated based on a write command input from an external unit. The write command is an instruction to activate a write data to the predetermined memory.

### BACKGROUND OF THE INVENTION

1. Field of the Invention

The present invention relates to a memory controller, particularly to a memory controller having a write buffer. Moreover, the present invention relates to a write control method, particularly to a write control method applied to such memory controller.

2. Background Information

A conventional memory controller 900 and a peripheral structure thereof is shown in FIG. 1. As shown in FIG. 1, the memory controller 900 has a write buffer 910 including N stages of word buffers wbuff 0 to wbuff N (N is a positive integer), and it is connected with a CPU 100 via a system bus 101. The system bus 101 includes a bus line ‘wdata’ for transmitting writing object data (hereinafter referred to as write data) “wdata”, a bus line ‘add’ for transmitting an access destination address “addr” output from the CPU 100, and a bus line ‘write’ for transmitting a command “write” indicating that the access by the CPU 100 is for writing (hereinafter referred to as write access), and a bus line ‘ready’ for transmitting a response signal “ready” indicating that the memory controller 900 is ready for the write access.

In addition, the memory controller 900 is connected with a memory 300 via a system bus. This system bus includes a bus line ‘maddr’ for transmitting row address and column address generated by having the address “addr” received from the CPU decoded, a bus line ‘mdata’ for transmitting the write data read out from the write buffer 910, and a bus line ‘command’ for transmitting a command “ACT” for activating a writing object row address and for transmitting a command “WRITE” for activating a writing object column address.

Now, operation of the memory controller 900 shown in FIG. 1 will be explained using a timing chart shown in FIG. 2. In FIG. 2, for the convenience of explanation, the write buffer 910 in the memory controller 900 is set to be a four-stage write buffer (i.e., N=4). FIG. 2 shows the operation at the time when the CPU 100 executes write access to four consecutive addresses from an address “addr”=A to an address “addr”=A+3. In addition, FIG. 2 shows a case in which a RAS-CAS delay is worth two cycles.

For instance, as shown in FIG. 2, when a command “write”=1 and an address “addr”=A are output from the CPU 100 as write access at timing T2, the memory controller 900 will receive these outputs from the CPU 100, and at the same timing T2, generate a response signal “ready”=1 and send this response signal “ready”=1 to the CPU 100. Then, at timing T4, the memory controller 900 will receive write data “wdata”=D output at timing T3 from the CPU 100 which have received the response signal “ready”=1, and store this write data “wdata”=D to the first stage of the write buffer 910 (i.e., wbuff 0). Then, based on the write accesses output from the CPU 100 at timings T3 to T5, respectively (i.e., the command “write”=1, the addresses “addr”=A+1 to A +3), the memory controller 900 will receive sequentially at timings T5, T6 and T7 write data “wdata”=D+1, D+2 and D+3 output from the CPU 100 at timings T4, T5 and T6, respectively, and store these write data “wdata” to the write buffer 910 (i.e., wbuff 1 to wbuff 3), respectively.

In addition, when the fourth write access (i.e., the command “write”=1, the address “addr”=A+3) is output from the CPU 100 at timing T5 to the memory controller 900, the memory controller 900 will determine that the write buffer 910 is full. Having determined that the write buffer 910 is full, the memory controller 900 will generate a command “ACT”, and at the same time, the memory controller 900 will generate row addresses by decoding the addresses “addr”=A to A+3 and output these row addresses to the memory 300 at timing T6. Then, after the RAS-CAS delay, the memory controller 900 will output the generated command “WRITE” and column addresses generated by decoding the addresses “addr”=A to A+3 to the memory 300 at timing T8. Through these processes, the memory controller 900 will specify the writing object address, and at the same time, the memory controller 900 will supply the write data “wdata”=D stored in the fist stage of the write buffer 910 (i.e., wbuff 0) to the memory 300 as write data “mdata”. By this process, the first write data “wdata” will be written into the memory 300. Then, the memory controller 900 will sequentially supply the write data “wdata”=D+1 to D+3 of the write buffer 910 (i.e., wbuff 1 to wbuff 3) to the memory 300 at timings T9 to T11, respectively. By this process, these data will be written into the memory 300. Thus, the writing operation with respect to the memory 300 will be terminated.

For example, Japanese Laid-Open Patent Application No. 5-12121 (hereinafter referred to as patent reference 1) discloses a technology for speeding up the data writing operation after the second data when multiple data are supposed to be consecutively written into the same row address, for instance.

In such conventional technology, however, when writing data stored in the write buffer of the memory controller into the memory, the memory controller will issue the command “ACT” after conditions are met for writing to the memory from the writing buffer, and then after the RAS-CAS delay, the memory controller will issue the command “WRITE” in order to execute the actual write access. Therefore, a few cycles are required until the command “WRITE” can be issued after conditions are met for writing to the memory from the writing buffer, which causes a problem in which high-speed writing is disabled.

The conventional technology as disclosed in patent reference 1 relates to technology for speeding up the data writing operation after the second data by applying a high-speed access mode, when multiple data are supposed to be consecutively written into consecutive addresses. Therefore, unlike the present invention, it is not capable of resolving problems such as increasing the speed with which data is written into the memory from the writing buffer.

In view of the above, it will be apparent to those skilled in the art from this disclosure that there exists a need for an improved memory controller. This invention addresses this need in the art as well as other needs, which will become apparent to those skilled in the art from this disclosure.

### SUMMARY OF THE INVENTION

It is therefore an object of the present invention to resolve the above-described problems, and to provide a memory controller and a write control method capable of increasing the speed with which data is written into a memory.

In accordance with one aspect of the present invention, a memory controller comprises a plurality of buffers and a controller. The buffers are configured to connect with a predetermined memory. The controller issues a first command before all the buffers store data. The first command is an instruction to activate a row address corresponding to a predetermined memory region in the predetermined memory, and it is generated based on a write command input from an external unit. The write command is an instruction to activate write data to the predetermined memory.

These and other objects, features, aspects, and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a block diagram showing a conventional memory controller and a peripheral structure thereof;

FIG. 2 is a timing chart for explaining the operation of the conventional memory controller shown in FIG. 1;

FIG. 3 is a block diagram showing a memory controller according to a first embodiment of the present invention and a peripheral structure thereof,

FIG. 4 is a circuit diagram showing a command controller in the memory controller according to the first embodiment of the present invention;

FIG. 5 is a transition sequence of the counter value of a buffer counter in the memory controller according to the first embodiment of the present invention;

FIG. 6 is a circuit diagram showing a write buffer in the memory controller according to the first embodiment of the present invention;

FIG. 7 is a timing chart for explaining the operation of the memory controller according to the first embodiment of the present invention;

FIG. 8 is a block diagram showing a memory controller according to a second embodiment of the present invention and a peripheral structure thereof,

FIG. 9 is a circuit diagram showing a CKE controller in the memory controller according to the second embodiment of the present invention; and

FIG. 10 is a timing chart for explaining the operation of the memory controller according to the second embodiment of the present invention.

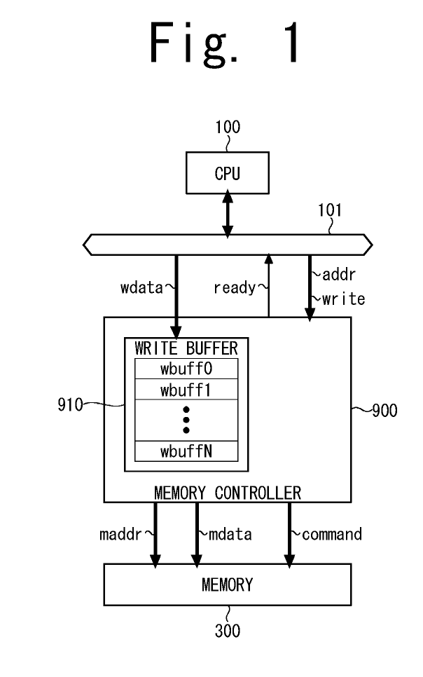

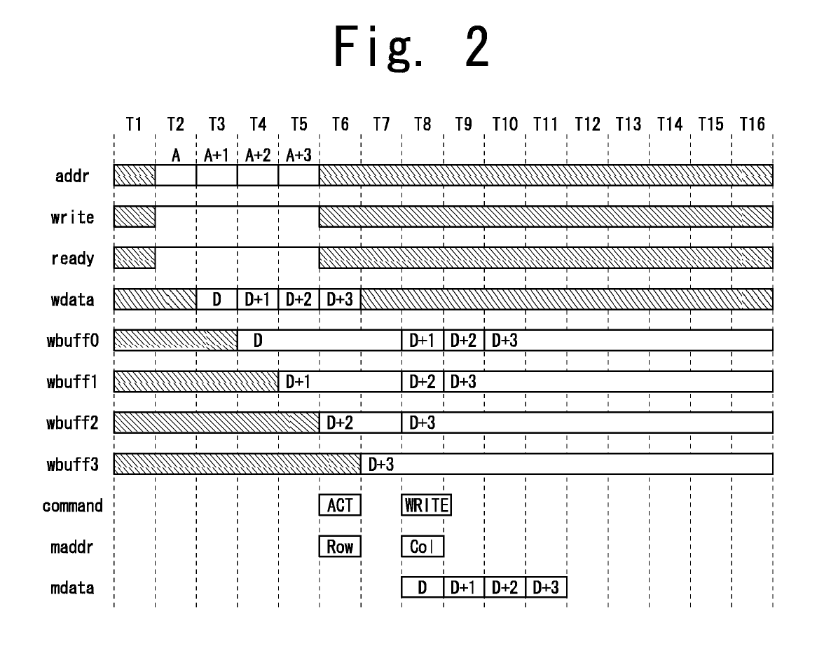

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### FIRST EMBODIMENT

First, a first embodiment of the present invention will be described in detail with reference to the drawings. This embodiment shows an example of a memory controller which is structured to speed up writing into a memory by issuing a command “ACT” (i.e., a first command) for activating a row address prior to reading out write data from a write buffer and writing into the memory. In this embodiment, for the convenience of explanation, the write buffer of the memory controller is set to be a four-stage write buffer (i.e., N=4). Furthermore, this embodiment will show the operation at the time when a CPU executes write access to four consecutive addresses from an address “addr”=A to an address “addr”=A+3. In addition, this embodiment will show a case in which a RAS-CAS delay is worth two cycles.

Structure

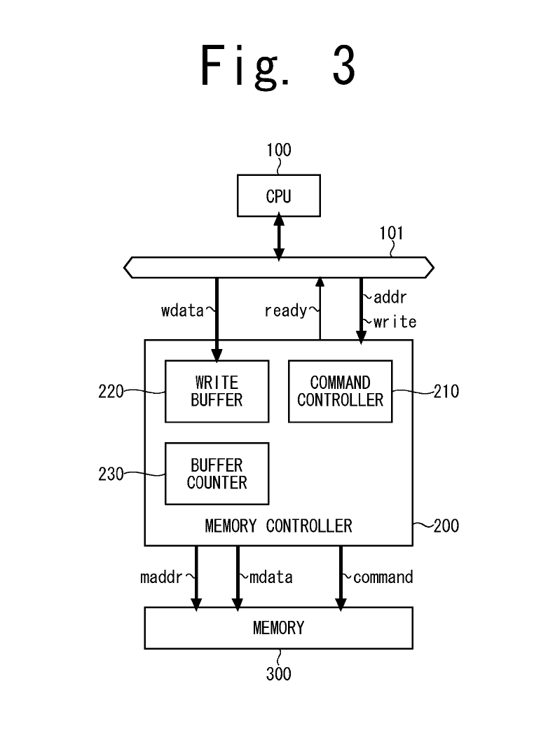

FIG. 3 is a block diagram showing a memory controller 200 according to the first embodiment of the present invention and a peripheral structure of the memory controller 200. As shown in FIG. 3, the memory controller 200 has a command controller 210, a write buffer 220, and a buffer counter 230, and it is connected to a CPU 100 via a system bus 101. This system bus 101 includes a bus line ‘wdata’ for transmitting write data “wdata”, a bus line ‘add’ for transmitting an access destination address “addr” output from the CPU 100, and a bus line ‘write’ for transmitting a command “write” indicating that the access by the CPU 100 is for writing (i.e., write access), and a bus line ‘ready’ for transmitting a response signal “ready” indicating that the memory controller 200 is ready for the write access. In this regard, any sending/receiving of signals via the system bus 101 is conducted based on a system clock. The memory controller 200 also operates based on the system clock.

In addition, the memory controller 200 is connected with a memory 300 via a system bus. This system bus includes a bus line ‘maddr’ for transmitting a row address and column address generated by having the address “addr” received from the CPU decoded, a bus line ‘mdata’ for transmitting the write data read out from the write buffer 220, and a bus line ‘command’ for transmitting a command “ACT” for activating a writing object row address and for transmitting a command “WRITE” (i.e., a second command) for activating a writing object column address.

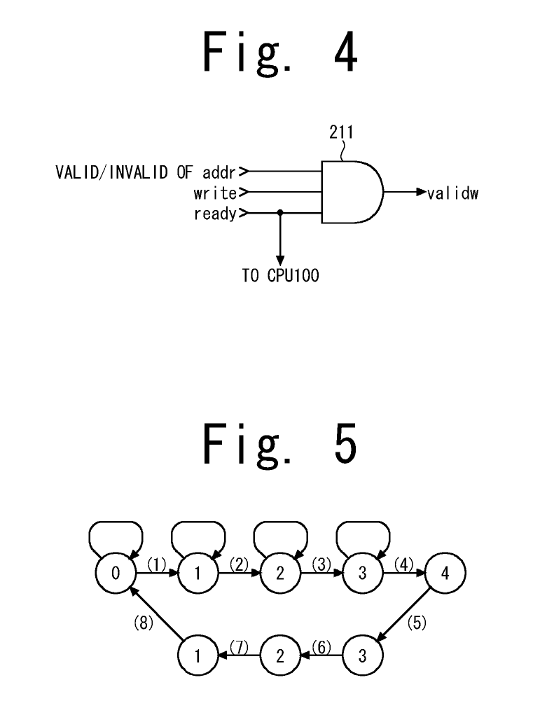

The command controller 210 in the above structure functions to generate all kinds of commands (i.e., command “ACT”, command “WRITE”, etc.) and addresses (i.e., row address, column address, etc.) for controlling writing to the memory 300 in response to write access by the CPU 100. As shown in FIG. 4, this command controller 210 has an AND circuit 211 with three inputs and one output. Information as to whether an address “addr” output from the CPU 100 is valid or not is supposed to be input to one of the three inputs of the AND circuit 211. In this regard, when the address “addr” is valid, ‘1’ will be input, while when the address “addr” is invalid, ‘0’ will be input, for instance. To the other one of the inputs of the AND circuit 211, a command “write” is supposed to be input. In this regard, when the address “write” is valid, ‘1’ will be input, while when the address “write” is invalid, ‘0’ will be input. To the remaining one of the three inputs of the AND circuit 211, a response signal “ready” is supposed to be input. In this regard, when the response signal “ready” is valid, ‘1’ will be input, while when the response signal “ready” is invalid, ‘0’ will be input. Therefore, the AND circuit 211 will output a write access signal “validw” indicating ‘1’ only when the address “addr”, the command “write”, and the response signal “ready” are all valid (i.e., ‘1’). In other circumstances, the AND circuit 211 will output a write access signal “validw” indicating ‘0’.

The command controller 210 having this type of AND circuit 211 will output a command “ACT” when the write access signal “validw” is ‘1’ and the counter value of the buffer counter 230 (which will be described in more detail later on) indicates ‘0’. On the other hand, the command controller 210 will output a command “WRITE” when the counter value of the buffer counter 230 indicates the same value as the number of stages of the write buffer 220 (i.e., ‘4’ in this description). In other cases, the command controller 210 will be in an idle state and will not issue any command.

The buffer counter 230 in the above structure functions as a counter for controlling the number of write data “wdata” stored in the write buffer 220. FIG. 5 shows the transition sequence of the counter value of the buffer counter 230. Here, if the initial value of the buffer counter 230 is ‘0’, for instance, the counter value of the buffer counter 230 will be incremented from ‘0’ up until ‘4’ one by one, as shown by (1) to (4) in FIG. 5. Then after that, the counter value of the buffer counter 230 will be decremented from ‘4’ down until ‘0’ one by one, as shown by (5) to (8) in FIG. 5. The count up indicated by (1) to (4) in FIG. 5 will be executed every time a write access signal “validw” indicating ‘1’ is output from the command controller 210. The address “addr”, the command “write” and the response signal “ready” are supposed to be output at every one system clock. Therefore, the write access signal “validw” is supposed to be output from the command controller 210 at every one system clock. In the meantime, the count down indicated by (5) to (8) in FIG. 5 will be executed according to the system clock at the time when the write access signal “validw” indicates ‘0’.

In this way, the buffer counter 230 in this embodiment will count up every time it receives a write access signal “validw”=1 indicating a write access by the CPU 100, while it will count down to ‘0’ based on the system clock when the write buffer becomes full. In this embodiment, since the writer buffer 220 has a four-stage structure, when it becomes full, the counter value of the buffer counter 230 will indicate ‘4’. Accordingly, when the counter value of the buffer counter 230 becomes ‘4’, from that point on, the buffer counter 230 will decrement the counter value down to ‘0’.

In addition, the buffer counter 230 in this embodiment also functions to control the timing of at which all kinds of commands directed to the memory 300 are issued. At the time when the counter value shifts from ‘0’ to ‘1’, the buffer counter 230 will issue a row address and a command “ACT” based on the address “addr” and the command “write” input from the CPU 100 and output them to the memory 300. Thereby, the memory 300 will be in a standby state with respect to writing. In the meantime, when the counter value shifts from ‘4’ to ‘3’, the buffer counter 230 will issue a column address and a command “WRITE” also based on the address “addr” and the command “write” input from the CPU 100 and output them to the memory 300. Thereby, writing of the write data “wdata” into the memory 300 will start. In the cases other than the case where the counter value shifts from ‘0’ to ‘1’ and the case where the counter value shift from ‘4’ to ‘3’, the counter 230 will be in an idle state and will not issue any command.

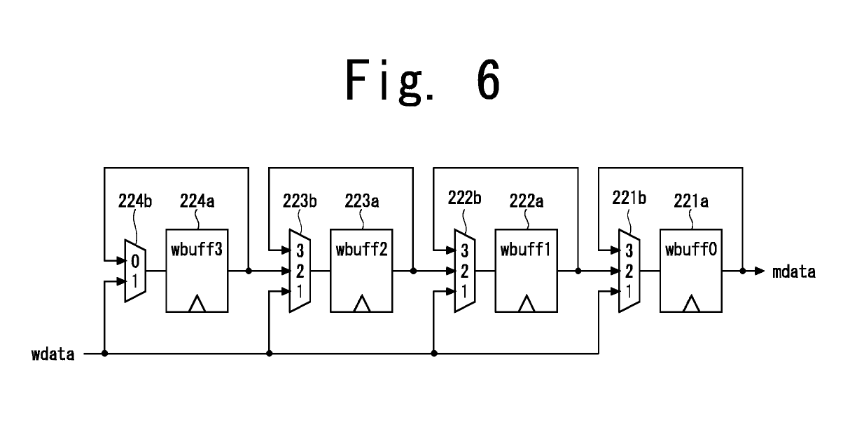

The write buffer 220 in the above structure functions to temporary store the write data “wdata” to be written into the memory 300. FIG. 6 shows the circuit structure of the write buffer 220. As shown in FIG. 5, the write buffer 220 includes four buffers 221a to 224a (i.e., wbuff 0 to wbuff 4), and multiplexers 221b to 224b which are disposed at input stages of the buffers 221a to 224a, respectively.

In this structure, the multiplexer 221b disposed at the input stage of the buffer 221a (i.e., wbuff 0) of the first stage has three inputs ‘1’ to ‘3’ and one output. To the input ‘1’, the write data “wdata” output from the CPU 100 is supposed to be input. To the input ‘2’, the output from the buffer 222a (i.e., wbuff 1) of the second stage is supposed to be input. To the input ‘3’, the output from the buffer 221a (i.e., wbuff 0) of the first stage is supposed to be fed back.

This multiplexer 221b will output to the buffer 221a (i.e., wbuff 0) of the first stage the write data “wdata” having been input to the input ‘1’, when the write access signal “validw” output from the command controller 210 is ‘1’ and the counter value of the buffer counter 230 is ‘1’. Thereby, the write data “wdata”=D output from the CPU 100 will be stored in the buffer 221a (i.e., wbuff 0) of the first stage. Moreover, when the write data “wdata” output from the buffer 221a (i.e., wbuff 0) of the first stage is fed back to the input ‘3’, the multiplexer 221b will erase the write data “wdata” stored in the buffer 221a (i.e., wbuff 0) of the first stage. The write data “wdata” output from the buffer 221a (i.e., wbuff 0) of the first stage will be written into the memory 300. Furthermore, when the write data “wdata” is input to the input ‘2’ from the buffer 222a (i.e., wbuff 1) of the second stage, the multiplexer 221b will output to the buffer 221a (i.e., wbuff 0) of the first stage the write data “wdata” having been input from the buffer 222a (i.e., wbuff 1) of the second stage. Thereby, the write data “wdata” stored in the buffer 222a (i.e., wbuff 1) of the second stage will move into the buffer 221a (i.e., wbuff 0) of the first stage.

As with the multiplexer 221b, the multiplexer 222b disposed at the input stage of the buffer 222a (i.e., wbuff 1) of the second stage has three inputs ‘1’ to ‘3’ and one output. The write data “wdata” output from the CPU 100 is supposed to be input to the input ‘1’. The output from the buffer 223a (i.e., wbuff 2) of the third stage is supposed to be input to the input ‘2’. The output from the buffer 222a (i.e., wbuff 1) of the second stage is supposed to be fed back to the input ‘3’.

This multiplexer 222b will output to the buffer 222a (i.e., wbuff 1) of the second stage the write data “wdata” having been input to the input ‘1’, when the write access signal “validw” output from the command controller 210 is ‘1’ and the counter value of the buffer counter 230 is ‘2’. Thereby, the write data “wdata”=D+1 output from the CPU 100 will be stored in the buffer 222a (i.e., wbuff 1) of the second stage. Moreover, when the write data “wdata” output from the buffer 222a (i.e., wbuff 1) of the second stage is fed back to the input ‘3’, the multiplexer 222b will erase the write data “wdata” stored in the buffer 222a (i.e., wbuff 1) of the second stage. The write data “wdata” output from the buffer 222a (i.e., wbuff 1) of the second stage will be stored in the input stage of the buffer 221a (i.e., wbuff 0) of the first stage via the multiplexer 221b. Furthermore, when the write data “wdata” is input to the input ‘2’ from the buffer 223a (i.e., wbuff 2) of the third stage, the multiplexer 222b will output to the buffer 222a (i.e., wbuff 1) of the second stage the write data “wdata” having been input from the buffer 223a (i.e., wbuff 2) of the third stage. Thereby, the write data “wdata” stored in the buffer 223a (i.e., wbuff 2) of the third stage will move into the buffer 222a (i.e., wbuff 1) of the second stage.

As with the multiplexers 221b and 222b, the multiplexer 223b disposed at the input stage of the buffer 223a (i.e., wbuff 2) of the third stage has three inputs ‘1’ to ‘3’ and one output. The write data “wdata” output from the CPU 100 is supposed to be input to the input ‘1’. The output from the buffer 224a (i.e., wbuff 3) of the fourth stage is supposed to be input to the input ‘2’. The output from the buffer 223a (i.e., wbuff 2) of the third stage is supposed to be fed back to the input ‘3’.

This multiplexer 223b will output to the buffer 223a (i.e., wbuff 2) of the third stage the write data “wdata” having been input to the input ‘1’, when the write access signal “validw” output from the command controller 210 is ‘1’ and the counter value of the buffer counter 230 is ‘3’. Thereby, the write data “wdata”=D+2 output from the CPU 100 will be stored in the buffer 223a (i.e., wbuff 2) of the third stage. Moreover, when the write data “wdata” output from the buffer 223a (i.e., wbuff 2) of the third stage is fed back to the input ‘3’, the multiplexer 223b will erase the write data “wdata” stored in the buffer 223a (i.e., wbuff 1) of the third stage. The write data “wdata” output from the buffer 223a (i.e., wbuff 2) of the third stage will be stored in the input stage of the buffer 222a (i.e., wbuff 1) of the second stage via the multiplexer 222b. Furthermore, when the write data “wdata” is input to the input ‘2’ from the buffer 224a (i.e., wbuff 3) of the fourth stage, the multiplexer 223b will output to the buffer 223a (i.e., wbuff 2) of the third stage the write data “wdata” having been input from the buffer 224a (i.e., wbuff 3) of the fourth stage. Thereby, the write data “wdata” stored in the buffer 224a (i.e., wbuff 3) of the fourth stage will move into the buffer 223a (i.e., wbuff 2) of the third stage.

In the meantime, the multiplexer 224b disposed at the input stage of the buffer 224a (i.e., wbuff 3) of the fourth stage has two inputs ‘0’ and ‘1’ and one output. The write data “wdata” output from the CPU 100 is supposed to be input to the input ‘1’. The output of the buffer 224a (i.e., wbuff 3) is connected so that the output from the buffer 224a can be fed back to the input ‘0’. In this embodiment, however, the buffer 224a (i.e., wbuff 3) of the fourth stage and the multiplexer 224b are structures which are actually not used. Therefore, they may be eliminated. The fourth write data “wdata”=D+3 (address “addr”=A+3) output from the CPU 100 will be the first to be stored in the buffer 223a (i.e., wbuff 2) of the third stage in the write buffer 220.

Operation

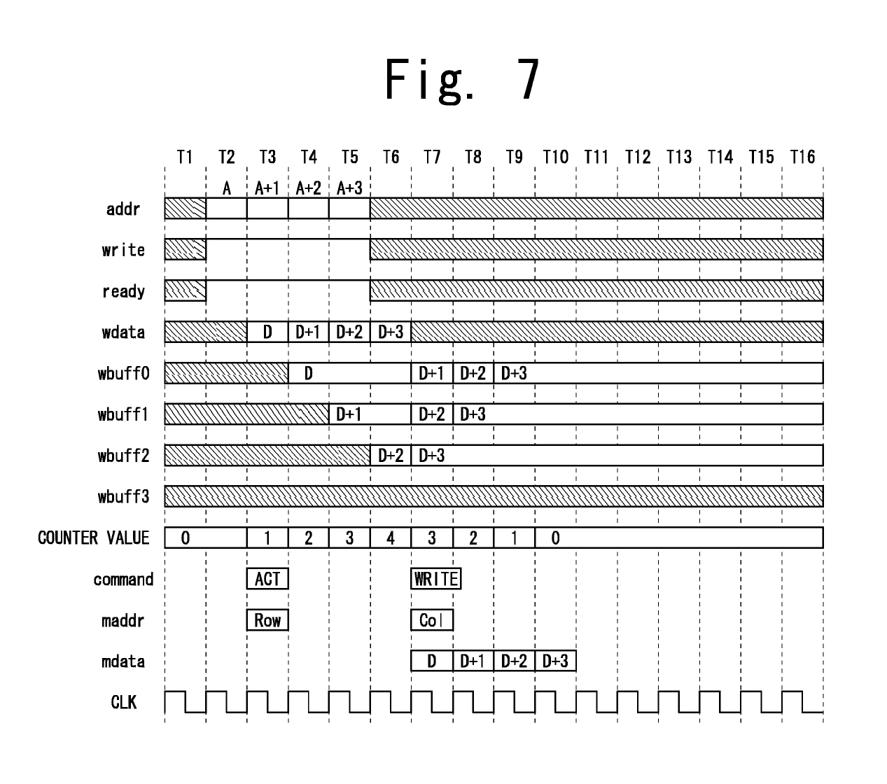

Now, operation of the memory controller 200 according to the first embodiment of the present invention will be explained in detail with reference to the drawings. FIG. 7 is a timing chart showing the operation of the memory controller 200. In FIG. 7, for the convenience of explanation, the write buffer 220 in the memory controller 200 is set to be a four-stage write buffer (i.e., N=4). FIG. 7 will show the operation at the time when the CPU 100 executes write access to four consecutive addresses from an address “addr”=A to an address “addr”=A+3. In addition, FIG. 7 shows a case in which a RAS-CAS delay is worth two cycles.

For instance, as shown in FIG. 7, when a command “write”=1 and an address “addr”=A are output from the CPU 100 as write access at timing T2, the memory controller 200 will receive these outputs from the CPU 100 at the same timing T2. Moreover, at the same timing T2, the memory controller 200 will generate a response signal “ready”=1 in the internal command controller 210 and send this response signal “ready”=1 to the CPU 100. At this time, since the address “addr”=A is valid (i.e., ‘1’), and the command “write” and the response signal “ready” are both ‘1’, the AND circuit 211 in the command controller 210 will generate a write access signal “validw”=1. When such write access signal “validw” =1 is generated, the buffer counter 230 will increment the counter value by one. In this case, the counter value of the buffer counter 230 will become ‘1’.

Furthermore, at this time, since the counter value of the buffer counter 230 will shift from ‘0’ to ‘1’, the memory controller 200 will generate a writing object row address and a command “ACT” for activating this writing object row address, based on the write access (i.e., command “write”=1, address “addr”=A) received from the CPU 100, and output them to the memory 300 at timing T3. That is, in this embodiment, by having the row address and the command “ACT” input to the memory 300 prior to having the entire write data “wdata” stored in the write buffer 220, it is possible to quicken the writing timing without being influenced by the RAS-CAS delay. Thereby, high speed writing operation is made possible.

When a response signal “ready”=1 responding to the write access (i.e., command “write”=1, address “addr”=A) is output from the memory controller 200 at timing T2, the CPU 100 will output write data “wdata”=D corresponding to the address “addr”=A at timing T3. In response to this, the memory controller 200 will receive the write data “wdata”=D output from the CPU 100, and write this data into the write buffer 220 at timing T4. In this regard, however, since the counter value of the buffer counter 230 at timing T3 is ‘1’ and the write access signal “validw” is ‘1’, the write data “wdata”=D will be stored in the buffer 221a (i.e., wbuff 0) of the first stage via the multiplexer 221b.

When the CPU 100 receives from the memory controller 200 the response signal “ready”=1 responding to the write access (i.e., command “write”=1, address “addr”=A) at the above-mentioned timing T2, the CPU 100 will output to the memory controller 200 a write access (i.e., command “write”=1, address “addr”=A+1) with respect to the next write data “wdata”=D+1 at timing T3. In response to this, the memory controller 200 will receive the output from the CPU 100 at the same timing T3. In addition, the memory controller 200 will generate a response signal “ready”=1 in the internal command controller 210 at timing T3 and send it to the CPU 100. At this time, since the address “addr”=A+1 is valid (i.e., ‘1’) and the command “write” and the response signal “ready” are both ‘1’, the AND circuit 211 in the command controller 210 will generate a write access signal “validw”=1. When the write access signal “validw”=1 is generated in this way, the buffer counter 230 will increment the counter value by one. In this case, the counter value of the buffer counter 230 will become ‘2’.

When a response signal “ready”=1 responding to the write access (i.e., command “write”=1, address “addr”=A+1) is output from the memory controller 200 at timing T3, the CPU 100 will output write data “wdata”=D+1 corresponding to the address “addr”=A+1 at timing T4. In response to this, the memory controller 200 will receive the write data “wdata”=D+1 output from the CPU 100, and write this data into the write buffer 220 at timing T5. In this regard however, since the counter value of the buffer counter 230 at timing T4 is ‘2’ and the write access signal “validw” is ‘1’, the write data “wdata”=D+1 will be stored in the buffer 222a (i.e., wbuff 1) of the second stage via the multiplexer 222b.

When the CPU 100 receives from the memory controller 200 the response signal “ready”=1 responding to the write access (i.e., command “write”=1, address “addr”=A+1) at the above-mentioned timing T3, the CPU 100 will output to the memory controller 200 a write access (i.e., command “write”=1, address “addr”=A+2) with respect to the next write data “wdata”=D+2 at timing T4. In response to this, the memory controller 200 will receive the output from the CPU 100 at the same timing T4. In addition, the memory controller 200 will generate a response signal “ready”=1 in the internal command controller 210 at timing T4 and send it to the CPU 100. At this time, since the address “addr”=A+2 is valid (i.e., ‘1’) and the command “write” and the response signal “ready” are both ‘1’, the AND circuit 211 in the command controller 210 will generate a write access signal “validw”=1. When the write access signal “validw”=1 is generated in this way, the buffer counter 230 will increment the counter value by one. In this case, the counter value of the buffer counter 230 will become ‘3’.

When a response signal “ready”=1 responding to the write access (i.e., command “write”=1, address “addr”=A+2) is output from the memory controller 200 at timing T4, the CPU 100 will output write data “wdata”=D+2 corresponding to the address “addr”=A+2 at timing T5. In response to this, the memory controller 200 will receive the write data “wdata”=D+2 output from the CPU 100, and write this data into the write buffer 220 at timing T6. In this regard however, since the counter value of the buffer counter 230 at timing T5 is ‘3’ and the write access signal “validw” is ‘1’, the write data “wdata”=D+2 will be stored in the buffer 223a (i.e., wbuff 2) of the third stage via the multiplexer 223b.

When the CPU 100 receives from the memory controller 200 the response signal “ready”=1 responding to the write access (i.e., command “write”=1, address “addr”=A+2) at the above-mentioned timing T4, the CPU 100 will output to the memory controller 200 a write access (i.e., command “write”=1, address “addr”=A+3) with respect to the next write data “wdata”=D+3 at timing T5. In response to this, the memory controller 200 will receive the output from the CPU 100 at the same timing T5. In addition, the memory controller 200 will generate a response signal “ready”=1 in the internal command controller 210 at timing T5 and send it to the CPU 100. At this time, since the address “addr”=A+3 is valid (i.e., ‘1’) and the command “write” and the response signal “ready” are both ‘1’, the AND circuit 211 in the command controller 210 will generate a write access signal “validw”=1. When the write access signal “validw”=1 is generated in this way, the buffer counter 230 will increment the counter value by one. In this case, the counter value of the buffer counter 230 will become ‘4’.

When a response signal “ready”=1 responding to the write access (i.e., command “write”=1, address “addr”=A+3) is output from the memory controller 200 at timing T5, the CPU 100 will output write data “wdata”=D+3 corresponding to the address “addr”=A+3 at timing T6. In response to this, the memory controller 200 will receive the write data “wdata”=D+3 output from the CPU 100, and write this data into the write buffer 220 at timing T7. In this regard, however, from timing T6 to timing T7, the counter value of the buffer counter 230 will be decremented from ‘4’ to ‘3’. Therefore, at timing T7, the write data “wdata”=D stored in the buffer 221a (i.e., wbuff 0) in the write buffer 220 will be written into the memory 300, the write data “wdata”=D+1 stored in the buffer 222a (i.e., wbuff 1) will be moved into the buffer 221a (i.e., wbuff 0), the write data “wdata”=D+2 stored in the buffer 223a (i.e., wbuff 2) will be moved into the buffer 222a (i.e., wbuff 1), and the newly input write data “wdata”=D+3 will be stored in the buffer 223a (i.e., wbuff 2) of the third stage via the multiplexer 223b.

Furthermore, as described above, since the counter value of the buffer counter 230 will be decremented from ‘4’ to ‘3’ from timing T6 to timing T7, the memory controller 200 will generate a writing object column address and a command “WRITE” for activating this writing object column address, based on the write access (i.e., command “write”, address “addr”) received from the CPU 100, and output them to the memory 300 at timing T7. That is, in this embodiment, by having the column address and the command “WRITE” input to the memory 300 simultaneously with the writing of the entire write data “wdata” into the write buffer 220, it is possible to quicken the writing timing without being influenced by the RAS-CAS delay. Thereby, a high speed writing operation is made possible.

Then the memory controller 200 will decrement the counter value of the buffer counter 230 down to ‘0’ on the basis of the system clock CLK, sequentially move each of the write data “wdata”=D+1 to D+3 stored in the buffers 221a to 223a in the write buffer 220, respectively, to the write buffer in the previous stage, and sequentially write the write data stored in the buffer 221a into the memory 300. Through these processes, the writing of write data into the memory 300 requested by the CPU 100 will be terminated.

As described above, the memory controller 200 in the first embodiment of the present invention has multiple (four in this embodiment) buffers 221a to 224a which temporary store write data “wdata” input from the outside such as a CPU 100, etc., and a command controller 210 which, before the write data “wdata” is stored to all of the buffers 221a to 224a, issues a command “ACT” for activating a row address in a predetermined memory region of a memory 300 based on a write access (i.e., command write, address “addr”) to the memory 300 from the outside.

In the conventional structure, the command “ACT” is issued after the write data “wdata” is stored into all of the multiple buffers 221a to 224a, and therefore, the writing timing will be delayed by as much as the time of RAS-CAS delay. However, in the structure according to this embodiment, the command “ACT” is issued to the memory 300 in advance before the write data “wdata” is stored into all of the multiple buffers 221a to 224a, and thereby, the writing timing can be quickened without being influenced by the RAS-CAS delay. Therefore, according to this embodiment of the present invention, a high speed writing operation is made possible.

Moreover, the command controller 210 in this embodiment is structured such that the command “ACT” is issued at the timing (i.e., timing T3 in this embodiment) before the write data “wdata” is first stored in the multiple buffers 221a to 224a. In other words, in this embodiment, the command “ACT” will be issued at the timing when all the multiple buffers 221a to 224a do not store the write data.

Furthermore, the memory controller 200 in this embodiment further includes a buffer counter 230 which controls the number of write data stored in the multiple buffers 221a to 224a. In this structure, the command controller 210 will determine whether or not the write data “wdata” stored in the multiple buffers 221a to 224a is the first data based on a counter value of the buffer counter 230.

In addition, the command controller 210 in this embodiment is structured such that a command “WRITE” for activating a column address in a predetermined memory region is issued when write data “wdata” of the same number as the number of buffers 221a to 224a are written into the multiple buffers 221a to 224a.

### SECOND EMBODIMENT

Now a second embodiment of the present invention will be described in detail with reference to the drawings. In the following description, the same reference numbers will be used for the same structural elements as those in the first embodiment, and redundant explanations thereof will be omitted. Moreover, the structure not mentioned in particular is the same as that in the first embodiment.

This embodiment will show an example of a memory controller which is structured to speed up writing into a memory by issuing a command “ACT” for activating a row address prior to reading out write data from a write buffer and write into the memory. In this embodiment, for the convenience of explanation, the write buffer of the memory controller is set to be a four-stage write buffer (i.e., N=4). Furthermore, this embodiment shows the operation at the time when a CPU executes write access to four consecutive addresses from an address “addr”=A to an address “addr”=A+3. In addition, this embodiment shows a case in which a RAS-CAS delay is worth two cycles.

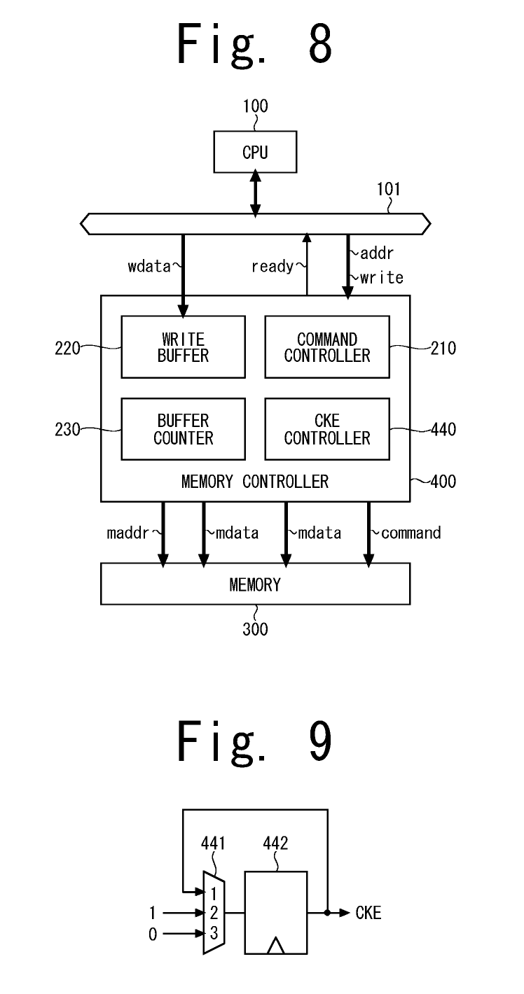

FIG. 8 is a block diagram showing a memory controller 400 according to the second embodiment of the present invention and a peripheral structure of the memory controller 400. As shown in FIG. 8, the memory controller 400 has the same structure as the memory controller 200 in the first embodiment except that the memory controller 400 further includes a clock enable controller (hereinafter referred to as a CKE controller) 440.

The CKE controller 440 (i.e., clock controller) functions to generate a clock enable signal CKE which enables or disables the supply of the system clock CLK to the memory 300, and by using the clock enable signal CKE, the memory 300 can be switched between an operative state and an inoperative state. Accordingly, the CKE controller 440 will contribute to a reduction in power consumption in the memory 300. In this embodiment, switching to the operative state or inoperative state is supposed to be done after two cycles from when the value of the clock enable signal CKE is altered.

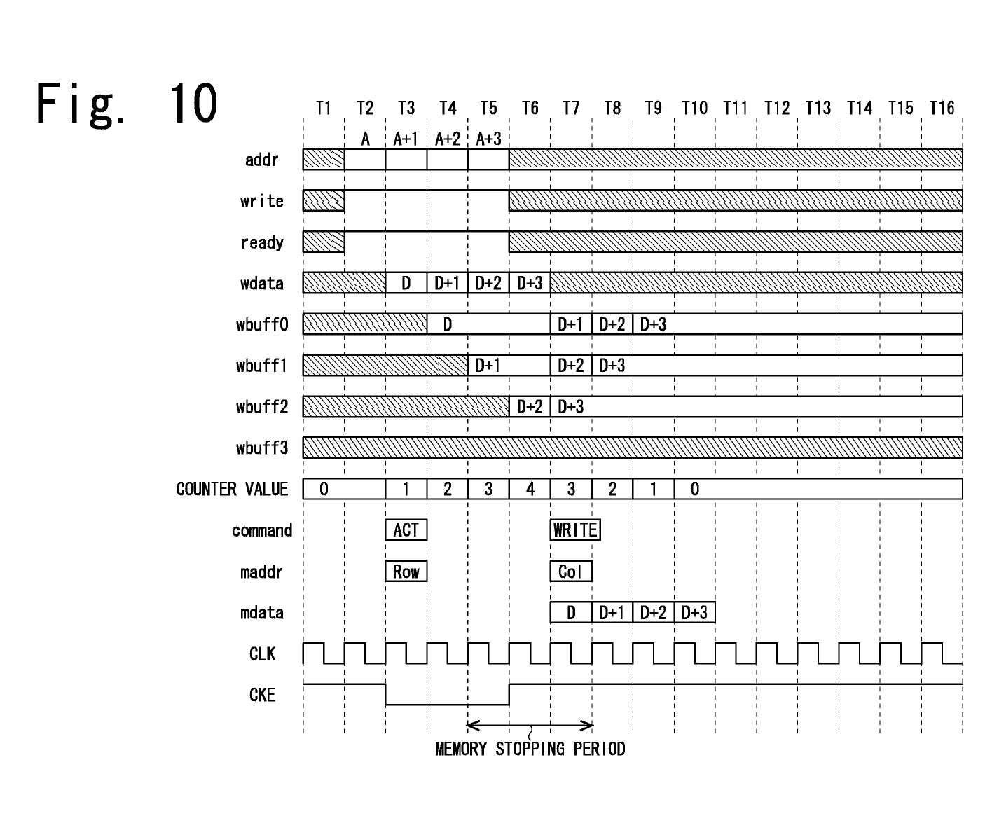

FIG. 9 shows a structure of the CKE controller 440 in this embodiment. As shown in FIG. 9, the CKE controller 440 includes a multiplexer 441 having three inputs ‘1’ to ‘3’ and one output, and a buffer 442 disposed at the output stage of the multiplexer 441.

In the above structure of the CKE controller 440, data ‘0’ will be input to the input ‘3’ of the multiplexer 441, data ‘1’ will be input to the input ‘2’ of the multiplexer 441, and an output from the buffer 442 will be fed back to the input ‘1’ of the multiplexer 441.

When the write access signal “validw” output from the command controller 210 is ‘1’ and the counter value of the buffer counter 230 is ‘1’, the multiplexer 441 will output the data ‘0’, having been input to its input ‘3’, to the buffer 442. Thereby, the buffer 442 will output a clock enable signal CKE of Low level (i.e., ‘0’), and then after a two-cycle period, the supply of the system clock CLK to the memory 300 will be stopped.

When the output from the buffer 442 is fed back to the input ‘1’ of the multiplexer 441, the multiplexer 441 will erase the value stored in the buffer 442.

In addition, When the write access signal “validw” output from the command controller 210 is ‘1’ and the counter value of the buffer counter 230 is ‘4’, the multiplexer 441 will output the data ‘1’ that was input to input ‘2’ to the buffer 442. Thereby, the buffer 442 will output a clock enable signal CKE of High level (i.e., ‘1’), and then after a two-cycle period, the supply of the system clock CLK to the memory 300 will be resumed.

Since the rest of the structure is the same as in the first embodiment, a detailed description thereof will be omitted here.

Operation

Now, operation of the memory controller 400 according to the second embodiment of the present invention will be explained in detail with reference to the drawings. FIG. 10 is a timing chart showing the operation of the memory controller 400. In FIG. 10, for the convenience of explanation, the write buffer in the memory controller 400 is set to be a four-stage write buffer (i.e., N=4). FIG. 10 shows the operation at the time when the CPU 100 executes write access to four consecutive addresses from an address “addr”=A to an address “addr”=A+3. In addition, FIG. 10 shows a case in which a RAS-CAS delay is worth two cycles.

As shown in FIG. 10, the memory controller 400 in this embodiment operates substantially in the same way as the memory controller 200 in the first embodiment, except that the memory controller 400 has an extra operation to control the supply of the system clock CLK to the memory 300 using a clock enable signal CKE. In the following, a description will be given that focuses mainly on this extra operation.

For instance, as shown in FIG. 10, when a command “write”=1 and an address “addr”=A are output from the CPU 100 as write access at timing T2, the memory controller 400 will receive these outputs from the CPU 100 at the same timing T2. Moreover, at the same timing T2, the memory controller 400 will generate a response signal “ready”=1 in the internal command controller 210 and send this response signal “ready”=1 to the CPU 100. At this time, since the address “addr”=A is valid (i.e., ‘1’), and the command “write” and the response signal “ready” are both ‘1’, the AND circuit 211 in the command controller 210 will generate a write access signal “validw”=1. When such write access signal “validw” =1 is generated, the buffer counter 230 will increment the counter value by one. In this case, the counter value of the buffer counter 230 will become ‘1’.

When the write access signal “validw” becomes ‘1’ and the counter value of the buffer counter 230 becomes ‘1’ in this way, the CKE controller 440 in the memory controller 400 will generate a clock enable signal of ‘0’ and supply this clock enable signal to the memory 300 at timing T3. Thereby, the memory 300 will stop operating after a two-cycle period, at timing T5.

Then, as write access (i.e., command “write“=1, address “addr”=A+1 to A+3) is output one after another from the CPU 100, the counter value of the buffer counter 230 in the memory controller 400 will become ‘4’ as in the case of the first embodiment. At this time, since the write access signal “validw” is ‘1’, the CKE controller 440 in the memory controller 400 will generate a clock enable signal of ‘1’ and supply this clock enable signal to the memory 300 at timing T6. Thereby, the memory 300 will resume operating after a two-cycle period, at timing T8.

Since the rest of the operation is the same as in the first embodiment, a detailed explanation thereof will be omitted here.

As described above, as with the case of the first embodiment of the present invention, the memory controller 400 in the second embodiment of the present invention has multiple (four in this embodiment) buffers 221a to 224a which temporary store write data “wdata” input from the outside such as a CPU 100, etc., and a command controller 210 which, before the write data “wdata” is stored to all of the buffers 221a to 224a, issues a command “ACT” for activating a row address in a predetermined memory region of a memory 300 based on a write access (i.e., command write, address “addr”) to the memory 300 from the outside.

In the conventional structure, the command “ACT” is issued after the write data “wdata” is stored into all of the multiple buffers 221a to 224a, and therefore, the writing timing will be delayed by as much as the time of RAS-CAS delay. However, in the structure according to this embodiment, the command “ACT” is issued to the memory 300 in advance before the write data “wdata” is stored into all of the multiple buffers 221a to 224a, and thereby, the writing timing can be quickened without being influenced by the RAS-CAS delay. Therefore, according to this embodiment of the present invention, a high speed writing operation is made possible.

Moreover, as with the case of the first embodiment of the present invention, the memory controller 400 in this embodiment is structured such that the command controller 210 will issue the command “ACT” at the timing (i.e., timing T3 in this embodiment) before the write data “wdata” is first stored in the multiple buffers 221a to 224a. In other words, in this embodiment, the command “ACT” will be issued at the timing when all the multiple buffers 221a to 224a do not store the write data.

Furthermore, as with the case of the first embodiment of the present invention, the memory controller 400 in this embodiment further includes a buffer counter 230 which controls the number of write data stored in the multiple buffers 221a to 224a. In this structure, the command controller 210 will determine whether or not the write data “wdata” stored in the multiple buffers 221a to 224a is the first data based on the counter value of the buffer counter 230.

In addition, as with the case of the first embodiment of the present invention, the memory controller 400 in this embodiment is structured such that the command controller 210 will issue a command “WRITE” for activating a column address in a predetermined memory region when write data “wdata” of the same number as the number of buffers 221a to 224a are written into the multiple buffers 221a to 224a.

Moreover, the memory controller 400 in the second embodiment of the present invention further includes a CKE controller 440 which stops the operation of the memory 300 for a period of time from when the command “ACT” is issued to when the command “WRITE” is issued

The CKE controller 440 functions to generate a clock enable signal CKE which enables or disables the supply of the system clock CLK to the memory 300, and using this clock enable signal CKE, the memory 300 can be switched between an operative state and an inoperative state. Thereby, the CKE controller 440 contributes to a reduction in the power consumption in the memory 300.

While the embodiments have been shown with respect to a DRAM (dynamic random access memory), a SDRAM (synchronous DRAM), etc., the present invention is not limited to such kinds of memories. Any kind of memory can be applied as long as it is a dynamic memory having the RAS-CAS delay and as long as it will not depart from the scope of the present invention.

While the preferred embodiments of the invention have been described using specific terms, such description is for illustrative purposes only, and it is to be understood that changes and variations may be made without departing from the spirit or the scope of the following claims.

This application claims priority to Japanese Patent Application No. 2005-281707. The entire disclosures of Japanese Patent Application No. 2005-281707 is hereby incorporated herein by reference.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

The term “configured” as used herein to describe a component, section or part of a device includes hardware and/or software that is constructed and/or programmed to carry out the desired function.

Moreover, terms that are expressed as “means-plus function” in the claims should include any structure that can be utilized to carry out the function of that part of the present invention.

The terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

In the present application, some aspects of the present invention as described above are not stated in the claims. These aspects include the following.

In accordance with a first aspect of the present invention, a write control method comprises the steps of receiving a write command inputted from an external unit; temporary storing write data inputted from an external unit in a plurality of buffers; and issuing a first command before all the buffers store data, the first command instructing to activate a row address corresponding to a predetermined memory region in the predetermined memory and being generated based on the write command.

In accordance with a second aspect of the present invention, the write control method according to the first aspect, wherein the first command is issued before initial data of the write data is stored in one of the buffers.

In accordance with a third aspect of the present invention, the write control method according to the second aspect, further comprises the steps of counting a number of data stored in the buffers using a counter; and determining as to whether data attempted to be written in the buffers is the initial data or not based on a value of the counter, wherein the first command is issued if the data attempted to be written in the buffers is the initial data.

In accordance with the fourth aspect of the present invention, the write control method according to the first, second or third aspect, further comprises the step of: issuing a second command for activating a column address corresponding to the predetermined memory region when the same number of data as the number of the buffers are written in the buffers.

In accordance with the fifth aspect of the present invention, the write control method according to the fourth aspect, further comprises the step of: turning OFF the predetermined memory during a period of time from when the first command is issued to when the second command is issued.

What is claimed is:

1. A memory controller comprising:
a plurality of buffers configured to connect with a predetermined memory; and
a controller configured to issue a first command before all the buffers store data, the first command comprising an instruction to activate a row address corresponding to a predetermined memory region in the predetermined memory, and being generated based on a write command input from an external unit that will activate write data to the predetermined memory.

2. The memory controller according to claim 1, wherein
the controller is configured to issue the first command before initial data of the write data is stored in one of the buffers.

3. The memory controller according to claim 2, further comprising:
a counter configured to count the number of data stored in the buffers, and
wherein the controller will determine whether or not data to be written in the buffers is the initial data based on the count value of the counter.

4. The memory controller according to claim 1, wherein
the controller is configured to issue a second command for activating a column address corresponding to the predetermined memory region when the same number of data as the number of the buffers are written in the buffers.

5. The memory controller according to claim 2, wherein
the controller is configured to issue a second command for activating a column address corresponding to the predetermined memory region when the same number of data as the number of the buffers are written in the buffers.

6. The memory controller according to claim 3, wherein
the controller is configured to issue a second command for activating a column address corresponding to the predetermined memory region when the same number of data as the number of the buffers are written in the buffers.

7. The memory controller according to claim 4, further comprising:
a clock controller configured to turn OFF the predetermined memory during a period of time from when the first command is issued to when the second command is issued.
